(19) United States
(12) Patent Application Publication
(10) Pub. No.: US 2018/0156068 A1
(43) Pub. Date: Jun. 7, 2018

(54) A TURBINE RING ASSEMBLY

(71) Applicant: SAFRAN AIRCRAFT ENGINES, Paris (FR)

(72) Inventors: Clement ROUSSILLE, Bordeaux (FR); Gael EVAIN, Bernay-Vilbert (FR); Adele LYPRENDI, Albi (FR); Lucien QUENNEHEN, Paris (FR)

(73) Assignee: SAFRAN AIRCRAFT ENGINES, Paris (FR)

(21) Appl. No.: 15/576,157

(22) PCT Filed: May 18, 2016
(86) PCT No.: PCT/FR2016/051168

§ 371 Date: Nov. 21, 2017

(30) Foreign Application Priority Data
May 22, 2015 (FR) 1554626

(51) Int. Cl. F01D 25/24; F01D 25/00

(52) U.S. Cl. CPC F01D 25/24; F05D 2300/6033; F01D 25/005

(57) ABSTRACT

A turbine ring assembly includes both a plurality of ring sectors made of ceramic matrix composite material forming a turbine ring, and also a ring support structure. Each ring sector includes a portion forming an annular base with an inner face defining the inside space of the turbine ring and an outer face from which an attachment portion of the ring sector extends for attaching it to the ring support structure. The ring support structure includes two annular flanges between which the attachment portion of each ring sector is held. Each annular flange of the ring support structure presents at least one sloping portion bearing against the attachment portions of the ring sectors, the sloping portion, when observed in meridian section, forming a non-zero angle relative to the radial direction and relative to the axial direction.

### BACKGROUND OF THE INVENTION

The invention relates to a turbine ring assembly comprising a plurality of ring sectors made of ceramic matrix composite material, together with a ring support structure.

When turbine ring assemblies are made entirely out of metal, it is necessary to cool all of the elements of the assembly, and in particular the turbine ring that is subjected to the hottest stream. Such cooling has a significant impact on the performance of the engine since the cooling stream used is taken from the main stream through the engine. In addition, using metal for the turbine ring limits potential for increasing temperature in the turbine, even though that would enable the performance of aeroengines to be improved.

In an attempt to solve such problems, proposals have been made to have recourse to turbine ring sectors that are made of ceramic matrix composite (CMC) material in order to avoid making use of a metal material.

CMC materials present good mechanical properties making them suitable for constituting structural elements, and advantageously they conserve these properties at high temperatures. Using CMC materials has advantageously made it possible to reduce the cooling stream that needs to be used in operation, and thus to improve the performance of engines. In addition, using CMC materials advantageously makes it possible to reduce the weight of engines and to reduce the effect of expansion when hot as encountered with metal parts.

Nevertheless, existing proposed solutions may involve assembling a CMC ring sector by using metal attachment portions of a ring support structure, these attachment portions being subjected to the hot stream.

Consequently, the metal attachment portions are subjected to expansion when hot, and that can lead to the CMC ring sector being subjected to mechanical stress and being weakened.

Also known are Documents GB 2 480 766, EP 1 350 927, and US 2014/0271145, which disclose turbine ring assemblies.

There exists a need to improve existing turbine ring assemblies that use CMC material in order to reduce the magnitude of the mechanical stresses to which the CMC ring sectors are subjected in operation.

### OBJECT AND SUMMARY OF THE INVENTION

To this end, in a first aspect, the invention provides a turbine ring assembly comprising both a plurality of ring sectors made of ceramic matrix composite material forming a turbine ring, and also a ring support structure, each ring sector having a portion forming an annular base with an inner face defining the inside space of the turbine ring and an outer face from which an attachment portion of the ring sector extends for attaching it to the ring support structure, the ring support structure comprising two annular flanges between which the attachment portion of each ring sector is held, each annular flange of the ring support structure presenting at least one sloping portion bearing against the attachment portions of the ring sectors, said sloping portion, when observed in meridian section, forming a non-zero angle relative to the radial direction and relative to the axial direction.

The radial direction corresponds to the direction along a radius of the turbine ring (a straight line connecting the center of the turbine ring to its periphery). The axial direction corresponds to the direction of the axis of revolution of the turbine ring and also to the flow direction of the gas stream in the gas flow passage.

Using such sloping portions on the annular flanges of the ring support structure serves advantageously to compensate for expansion differences between the annular flanges and the attachment portions of the ring sector, thereby reducing the mechanical stresses to which the ring sectors are subjected in operation.

Preferably, at least one of the flanges of the ring support structure is elastically deformable. This makes it possible advantageously to compensate even better for differential expansion between the attachment portions of the CMC ring sectors and the flanges of the metal ring support structure without significantly increasing the stress that is exerted when “cold” by the flanges on the attachment portions of the ring sectors. In particular, both flanges of the ring support structure are elastically deformable or else only one of the two flanges of the ring support structure is elastically deformable.

In an embodiment, each of the annular flanges of the ring support structure may present first and second sloping portions bearing against the attachment portions of the ring sectors, each of said first and second sloping portions, when observed in meridian section, forming a non-zero angle relative to the radial direction and to the axial direction. In particular, the first sloping portion may bear against the upper halves of the attachment portions of the ring sectors, and the second sloping portion may bear against the lower halves of the attachment portions of the ring sectors.

The upper half of an attachment portion of a ring sector corresponds to the fraction of said attachment portion that extends radially between the zone halfway along the attachment portion and the end of the attachment portion situated beside the ring support structure. The lower half of an attachment portion of a ring sector corresponds to the fraction of the attachment portion extending radially between the zone halfway along the attachment portion and the end of the attachment portion situated beside the annular base.

In an embodiment, the ring support structure may present axial portions that bear against the attachment portions of the ring sectors, each axial portion possibly extending parallel to the axial direction, these axial portions possibly being formed by the annular flanges or by a plurality of fitted elements engaged without clearance when cold through the annular flanges. In particular, the attachment portions of the ring sectors may be held to the ring support structure via such axial portions.

In an embodiment, the annular flanges of the ring support structure may grip the attachment portions of the ring sectors over at least half of the length of said attachment portions.

In an embodiment, the annular flanges of the ring support structure may grip the attachment portions of the ring sectors at least at the radially outer ends of said attachment portions. The radially outer end of an attachment portion corresponds to the end of the attachment portion that is situated remote from the flow passage for the gas stream. In particular, the annular flanges of the ring support structure may grip the attachment portions of the ring sectors solely via the upper halves of said attachment portions.

In an embodiment, the attachment portion of each ring sector may be in the form of tabs extending radially. In particular, the radially outer ends of the ring sector tabs need not be in contact and the tabs of the ring sectors may define between them an internal ventilation volume for each of the ring sectors.

In an embodiment, the attachment portion of each of the ring sectors is in the form of a bulb.

In an embodiment, the ring sectors are of a section that is substantially Ω-shaped or substantially π-shaped.

The present invention also provides a turbine engine including a turbine ring assembly as described above.

The turbine ring assembly may form part of gas turbine of an aeroengine, or in a variant it may form part of an industrial turbine.

### BRIEF DESCRIPTION OF THE DRAWINGS

Other characteristics and advantages of the invention appear from the following description of particular embodiments of the invention, given as non-limiting examples, and with reference to the accompanying drawings, in which:

FIG. 1 is a meridian section view showing an embodiment of a turbine ring assembly of the invention;

FIG. 2 shows a detail of FIG. 1;

FIGS. 3 to 6 are meridian section views showing variant embodiments of turbine ring assemblies of the invention;

FIG. 7 shows the retention band used in the embodiment of FIG. 6;

FIGS. 8 to 10 show how ring sectors are mounted in the embodiment of FIG. 5; and

FIGS. 11 to 15 show how ring sectors are mounted in the embodiment of FIG. 6.

### DETAILED DESCRIPTION OF EMBODIMENTS

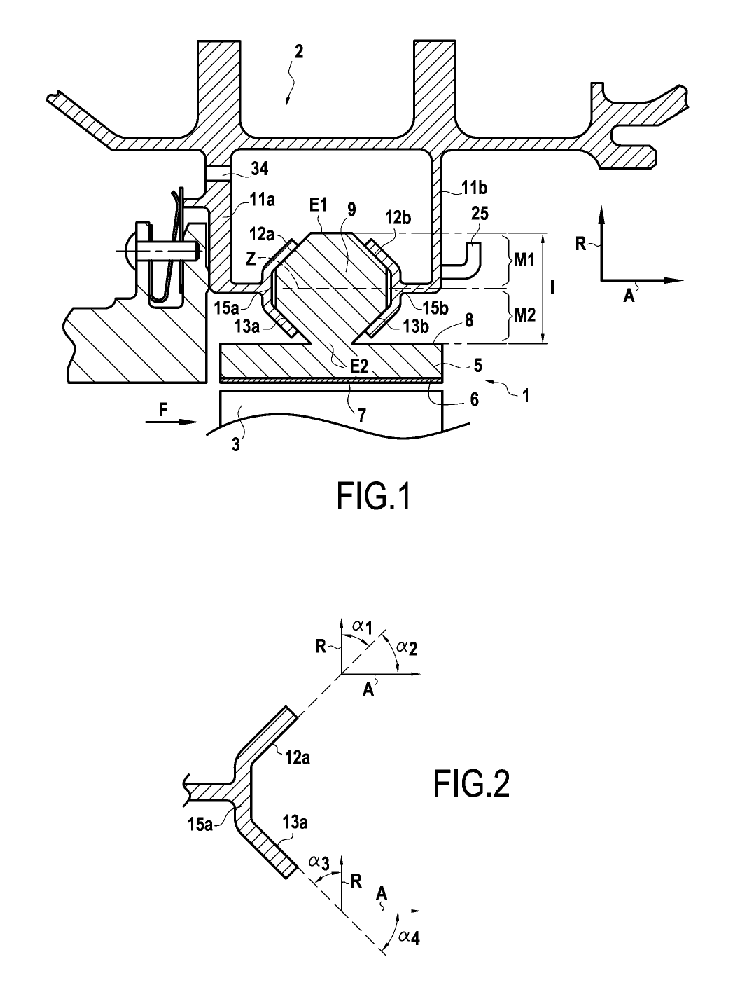

Below, the terms “upstream” and “downstream” are used with reference to the flow direction of the gas stream through the turbine (see arrow F in FIG. 1, for example).

FIG. 1 shows a turbine ring sector 1 and a casing 2 made of metal material constituting a ring support structure. The ring support structure 2 is made of a metal material such as the alloy Waspaloy® or the alloy Inconel® 718.

The ring sector assembly 1 is mounted on the casing 2 so as to form a turbine ring that surrounds a set of rotary blades 3. The arrow F shows the flow direction of the gas stream through the turbine. The ring sectors 1 are single pieces made of CMC. The use of a CMC material for making ring sectors 1 is advantageous in order to reduce the ventilation requirements of the ring. In the example shown, the ring sectors 1 are substantially Ω-shaped, with an annular base 5 having its radially inner face 6 coated in a layer 7 of abradable material to define the flow passage for the gas stream through the turbine. Furthermore, the annular base 5 has a radially outer face 8 from which there extends an attachment portion 9. In the example shown, the attachment portion 9 is in the form of a solid bulb, but it would not go beyond the ambit of the invention for the attachment portion to be in the form of a hollow bulb or for it to be in some other form as described in detail below. Sealing is provided between sectors by sealing tongues (not shown) received in grooves that face one another in the facing edges of two adjacent ring sectors.

Each above-described ring sector 1 is made of CMC by forming a fiber preform of shape close to the shape of the ring sector and by densifying the ring sector with a ceramic matrix. In order to make the fiber preform, it is possible to use yarns made of ceramic fiber, e.g. yarns made of SiC fibers such as those sold by the Japanese supplier Nippon Carbon under the name “Nicalon”, or yarns made of carbon fibers. The fiber preform is advantageously made by three-dimensional weaving, or by multilayer weaving. The weaving may be of the interlock type. Other three-dimensional or multilayer weaves may be used, such as for example multi-plain or multi-satin weaves. Reference may be made for this purpose to Document WO 2006/136755. After weaving, the blank may be shaped in order to obtain a ring sector preform that is subsequently consolidated and densified by a ceramic matrix, which densification may be performed in particular by chemical vapor infiltration (CVI), as is well known. A detailed example of fabricating CMC ring sectors is described in particular in Document US 2012/0027572.

The casing 2 has two annular radial flanges 11a and 11b made of metal material that extend radially towards a flow passage for the gas stream. The annular flanges 11a and 11b of the casing 2 grip the attachment portions 9 of the ring sectors 1 axially. Thus, as shown in FIG. 1, the attachment portions 9 of the ring sectors 1 are held between the annular flanges 11a and 11b, the attachment portions 9 being received between the annular flanges 11a and 11b. Furthermore, in conventional manner, ventilation orifices 34 formed in the flange 11a serves to bring air for cooling the outside of the turbine ring 1.

Each of the annular flanges 11a and 11b present two sloping portions bearing against the attachment portions 9 of the ring sectors 1 in order to hold them. The sloping portions of the annular flanges 11a and 11b are in contact with the attachment portions 9 of the ring sectors 1. The upstream annular flange 11a presents a first sloping portion 12a and a second sloping portion 13a. The flange 11a also presents a third portion 15a that extends in the radial direction R and that is situated between the first and second sloping portions 12a and 13a. The downstream annular flange 11b also presents a first sloping portion 12b and a second sloping portion 13b. The flange 11b also presents a third portion 15b extending in the radial direction R and situated between the first and second sloping portions 12b and 13b. When observed in meridian section, and as shown in FIGS. 1 and 2, the first sloping portion 12a of the upstream annular flange 11a forms a non-zero angle α₁ with the radial direction R and forms a non-zero angle α₂ with the axial direction A. Likewise, when observed in meridian section, the second sloping portion 13a of the upstream annular flange 11a forms a non-zero angle α₃ with the radial direction R and forms a non-zero angle α₄ with the axial direction A. The same applies to the first and second sloping portions 12b and 13b of the downstream annular flange 11b. The first and second sloping portions 12a and 13a extend in non-parallel directions (they form a non-zero angle relative to each other). The same applies for the first and second sloping portions 12b and 13b. As shown, the sloping portions of the annular flanges 11a and 11b extend so as to form a non-zero angle with the radial direction R and a non-zero angle with the axial direction A. In the example shown, each of the sloping portions of the annular flanges 11a and 11b extends in a straight line. In the example shown, each of the sloping portions 12a, 12b, 13a, and 13b is elongate in shape. When observed in meridian section, some or all of the sloping portions of the annular flanges 11a and 11b may form an angle lying in the range 30° to 60° with the radial direction. For each of the annular flanges 11a and 11b, the angle formed between its first sloping portion and the radial direction may optionally be equal to the angle formed between its second sloping portion and the radial direction, when the first and second sloping portions are observed in meridian section.

In the example shown, the annular flanges 11a and 11b grip the attachment portions 9 of the ring sectors over more than half of the length l of said attachment portions 9, in particular over at least 75% of this length. The length l is measured in the radial direction R.

In the example shown in FIG. 1, each of the first sloping portions 12a and 12b, when observed in meridian section, bears against the upper halves M₁ of the attachment portions 9, while each of the second sloping portions 13a and 13b, when observed in meridian section, bears against the lower halves M₂ of the attachment portions 9. The upper half M₁ corresponds to the fraction of the attachment portion 9 that extends radially between the zone Z halfway along the attachment portion 9 and the end E₁ of the attachment portion that is situated beside the ring support structure 2 (the radially outer end). The lower half M₂ corresponds to the fraction of the attachment portion 9 that extends radially between the zone Z halfway along the attachment portion 9 and the end E₂ of the attachment portion situated beside the annular base 5 (radially inner end). The sloping portions of the annular flanges 11a and 11b define two hooks between which the attachment portions 9 of the ring sectors 1 are gripped axially. In the example shown, each of these hooks presents substantially a C-shape.

Nevertheless, the invention is not limited to annular flanges each presenting such first and second sloping portions. Specifically, the description below covers situations in which each of the annular flanges presents a single sloping portion bearing against the attachment portions of the ring sectors.

As mentioned above, using sloping portions serves advantageously to compensate for expansion differences between the annular flanges 11a and 11b relative to the ring sectors 1, and also to reduce the mechanical stresses to which the ring sector 1 are subjected in operation.

In the embodiment of FIGS. 1 to 5, at least one of the annular flanges (flange 11b in FIG. 1) is provided, as shown, on its outside face with a hook 25 having a function that is described in detail below.

In the example shown in FIG. 1, the ring sectors are held to the ring support structure 2 solely by the annular flanges 11a and 11b (there are no additional fittings such as pegs passing through the attachment portions 9 of the ring sectors). As described in detail below, certain embodiments of the invention can make use of fittings to contribute to holding the ring sectors on the ring support structure.

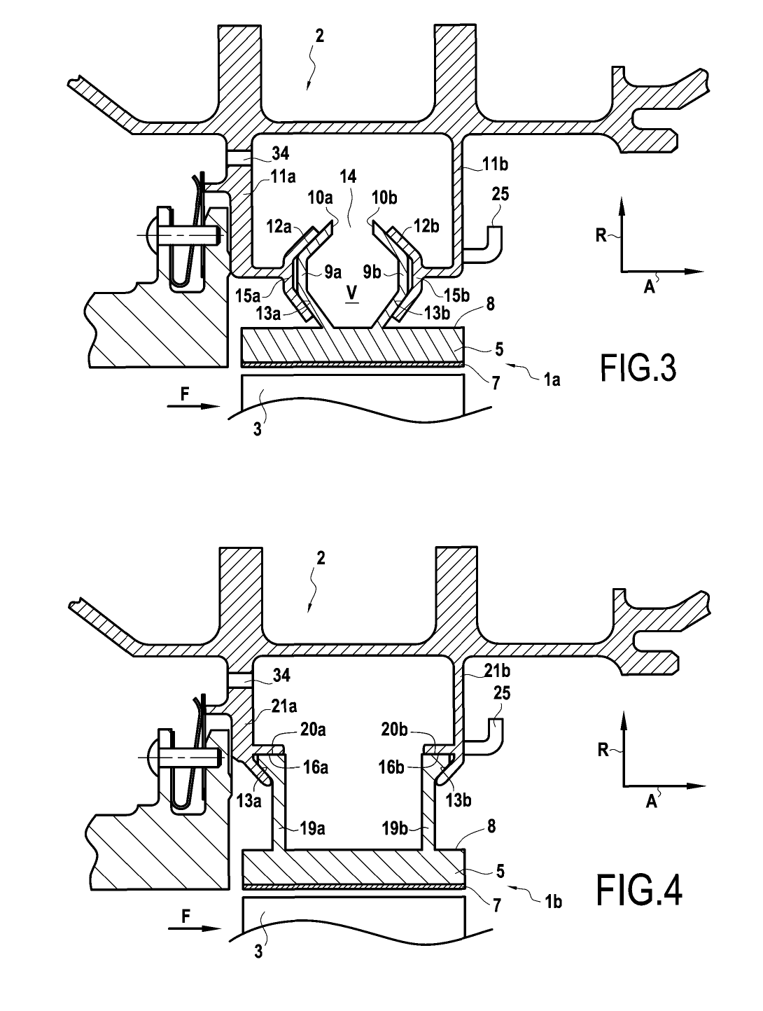

FIG. 3 shows a variant embodiment of the turbine ring assembly of the invention. In this example, the attachment portions of the ring sectors 1a are in the form of tabs 9a and 9b that extend radially from the outer face 8 of the annular base 5. In this example, the radially outer ends 10a and 10b of the tabs 9a and 9b of the ring sectors 1a do not come into contact. The radially outer end of a tab of a ring sector corresponds to the end of said tab that is situated remote from the flow passage for the gas stream. In the example shown in FIG. 3, the radially outer ends 10a and 10b are spaced apart along the axial direction A. The tabs 9a and 9b of the ring sectors define between them an internal ventilation volume V for each of the ring sectors 1a. It is thus possible to ventilate the ring sectors 1a by sending cooling air towards their annular bases 5 via the ventilation orifice 14 defined between the tabs 9a and 9b.

The ring sectors 1a of FIG. 3 present substantially an Ω-shape that is open at its end situated beside the ring support structure 2.

The fiber preform that is to form the ring sector 1a of the type shown in FIG. 3 may be made by three-dimensional weaving, or multilayer weaving, with zones of non-interlinking being provided to enable the preform portions corresponding to the tabs 9a and 9b to be moved away from the preform portion corresponding to the base 5. In a variant, the preform portions corresponding to the tabs may be made by weaving layers of yarns passing through the preform portion corresponding to the base 5.

FIG. 4 shows a variant embodiment in which the ring sectors 1b are held to the ring support structure 2 via annular flanges 21a and 21b, each presenting, as shown, an axial portion 16a or 16b extending parallel to the axial direction A. In addition, each of the annular flanges 21a and 21b presents a single sloping portion 13a or 13b bearing against the tabs 19a or 19b of the ring sectors 1b and forming a non-zero angle relative to the radial direction R and relative to the axial direction A. The axial portions 16a and 16b bear against the tabs 19a and 19b of the ring sectors. The tabs 19a and 19b forming the attachment portions of the ring sectors 1b are held to the ring support structure 2 via the axial portions 16a and 16b. The axial portions 16a and 16b formed by the annular flanges prevent the ring sectors 1b moving outwards in the radial direction R. The annular flanges 21a and 21b grip the tabs 19a and 19b of the ring sectors 1b axially at their radially outer ends 20a and 20b. In the example shown, the sloping portion and the axial portion of each of the annular flanges 21a and 21b together form a hook bearing against a tab 19a or 19b of the ring sectors 1b. The tabs 19a and 19b of the ring sectors 1b are griped axially between the two hooks formed by the annular flanges 21a and 21b. In the example shown in FIG. 4, the ring sectors 1b present a section that is substantially π-shaped.

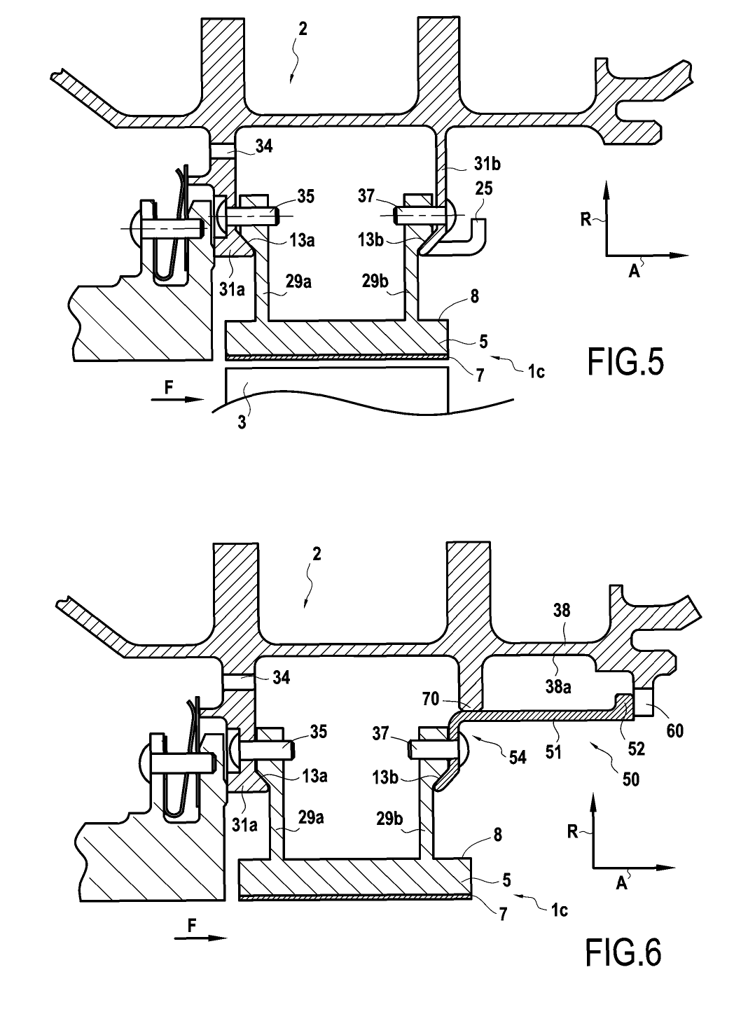

The embodiments that are described with reference to FIGS. 5 and 6 relate to the situation in which fitted elements are present through the attachment portions of the ring sectors in order to hold them. As explained above, the presence of such fitted elements is optional in the context of the present invention. FIG. 5 shows a variant embodiment in which the ring sectors 1c are held by blocking pegs 35 and 37. More precisely, and as shown in FIG. 5, the pegs 35 are engaged both in the upstream annular radial flange 31a of the ring support structure 2 and in the upstream tabs 29a of the ring sectors 1c. For this purpose, each peg 35 passes through a respective orifice formed in the upstream annular radial flange 31a and an orifice formed in each upstream tab 29a, the orifices in the flange 31a and in the tab 29a being put into alignment when mounting the ring sectors 1c on the ring support structure 2. Likewise, pegs 37 are engaged both through the downstream annular radial flange 31b of the ring support structure 2 and through the downstream tabs 29b of the ring sectors 1c. For this purpose, each peg 37 passes through a respective orifice formed in the downstream annular radial flange 31b and an orifice formed in each downstream tab 29b, the orifices in the flange 31b and the tabs 29b being put into alignment while mounting the ring sectors 1c on the ring support structure 2. The pegs 35 and 37 are engaged without clearance when cold through the flanges 31a and 31b and the tabs 29a and 29b. The pegs 35 and 37 serve to prevent the ring sectors 1c from turning. The pegs 35 and 37 prevent the ring sectors 1c moving towards the inside or towards the outside in the radial direction R. Each annular flange 31a and 31b also presents a single sloping portion 13a or 13b serving to reduce the stress applied to the ring sectors 1c when the annular flanges 31a and 31b expand in operation.

FIG. 6 shows a variant embodiment in which each ring sector 1c has a section that is substantially π-shaped with an annular base 5 having its inner face coated in a layer 7 of abradable material defining the flow passage for the gas stream through the turbine. Upstream and downstream tabs 29a and 29b extend in the radial direction R from the outer face of the annular base 5.

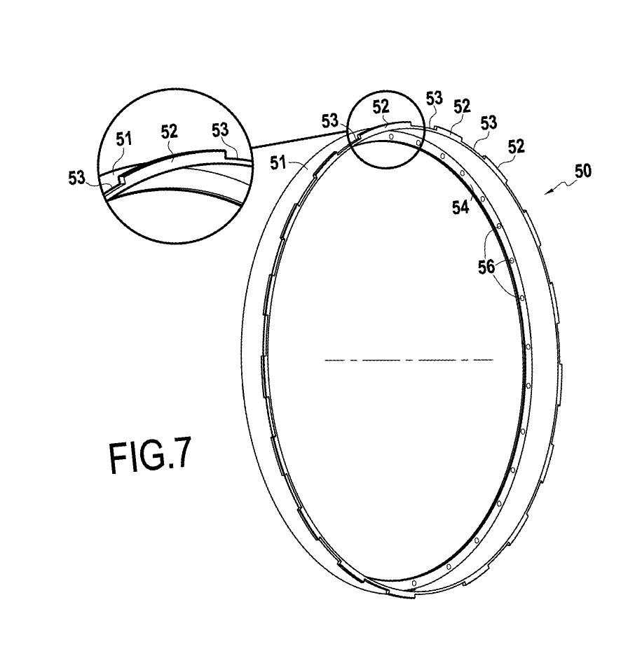

In this embodiment, the ring support structure 2 is made up of two portions, namely a first portion corresponding to an upstream annular radial flange 31a that is presently formed internally with a turbine casing, and a second portion corresponding to an annular retention band 50 mounted on the turbine casing. The upstream annular radial flange 31a includes a sloping portion 13a as described above bearing against the upstream tabs 29a of the ring sectors 1c. On its downstream side, the band 50 comprises an annular web 57 that forms a downstream annular radial flange 54 comprising a sloping portion 13b as described above bearing against the downstream tabs 29b of the ring sectors 1c. The band 50 comprises an annular body 51 extending axially and comprising, on its upstream side, the annular web 57, and on its downstream side, a first series of teeth 52 that are distributed circumferentially on the band 50 and that are spaced apart from one another by first engagement passages 53 (FIG. 7). On its downstream side, the turbine casing includes a second series of teeth 60 extending radially from the inside surface 38a of the shroud 38 of the turbine casing. The teeth 60 are distributed circumferentially on the inside surface 38a of the shroud 38 and they are spaced apart from one another by second engagement passages 61 (FIG. 13). The teeth 52 and 60 co-operate with one another to form a circumferential twist-lock law coupling.

The tabs 29a and 29b of each ring sector 1c are mounted with prestress between the annular flanges 31a and 54 so that, at least when “cold”, i.e. at an ambient temperature of about 25° C., the flanges exert a stress on the tabs 29a and 29b. Furthermore, as in the embodiment of FIG. 5, the ring sectors 1c are also held by blocking pegs 35 and 37.

At least one of the flanges of the ring support structure is elastically deformable, thereby serving even better to compensate differential expansion between the tabs of the ring sectors made of CMC and the flanges of the ring support structure made of metal, without significantly increasing the stress exerted when “cold” by the flanges on the tabs of the ring sectors.

Furthermore, the turbine ring assembly is provided with upstream to downstream sealing by an annular projection 70 extending radially from the inside surface 38a of the shroud 38 of the turbine casing and having its free end in contact with the surface of the body 51 of the ring 50.

There follows a description of two mounting methods suitable for mounting the ring sectors on the ring support structure.

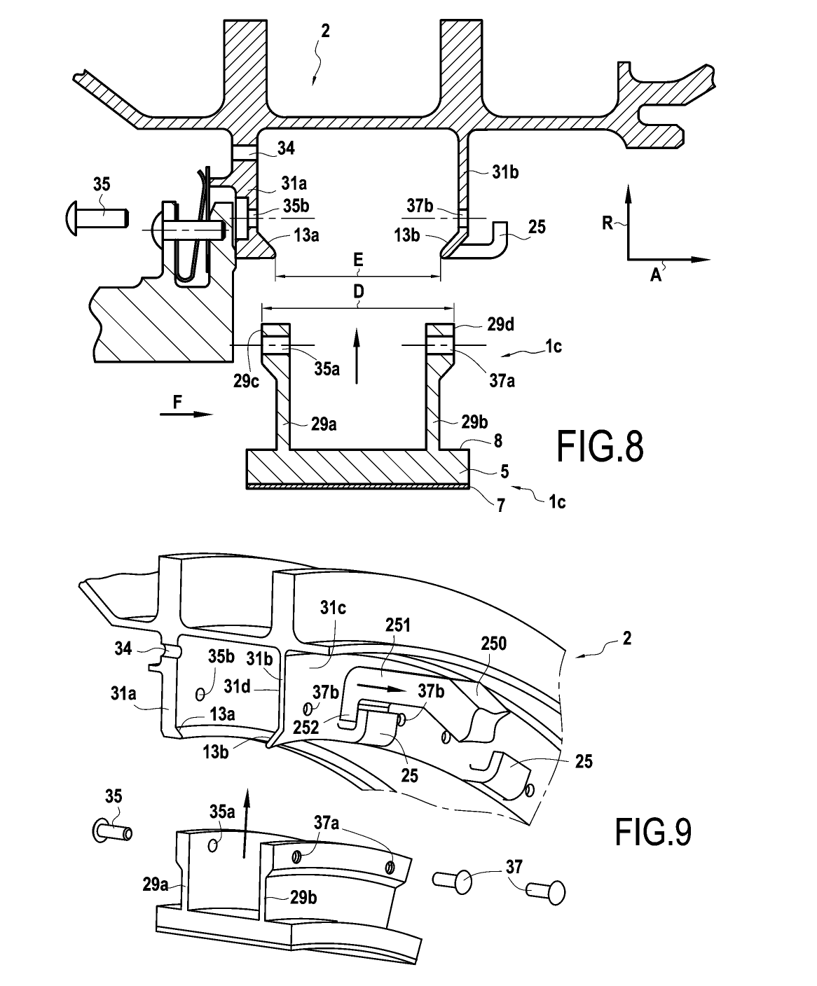

FIGS. 8 to 10 are described to illustrate mounting the ring sectors for the embodiment of FIG. 5. As shown in FIG. 8, the spacing E between the upstream annular radial flange 31a and the downstream annular radial flange 31b while at “rest”, i.e. when no ring sector is mounted between the flanges, is smaller than the distance D present between the outside faces 29c and 29d of the upstream and downstream tabs 29a and 29b of the ring sectors. The spacing E is measured between the ends of the sloping portions 13a and 13b of the annular flanges 31a and 31b.

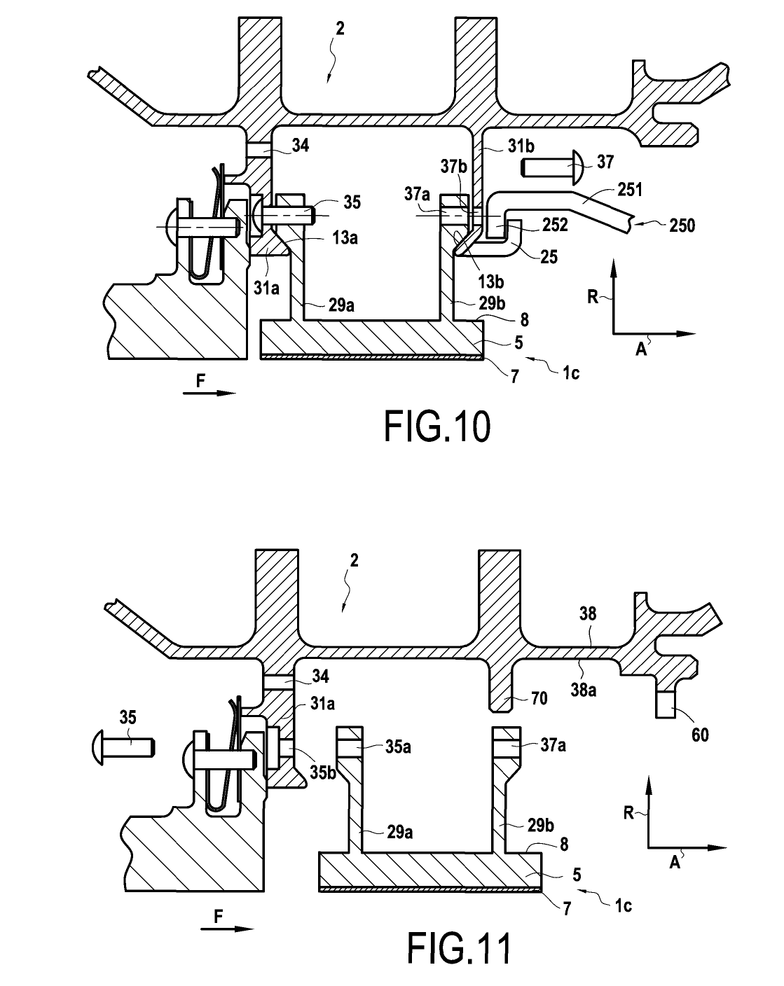

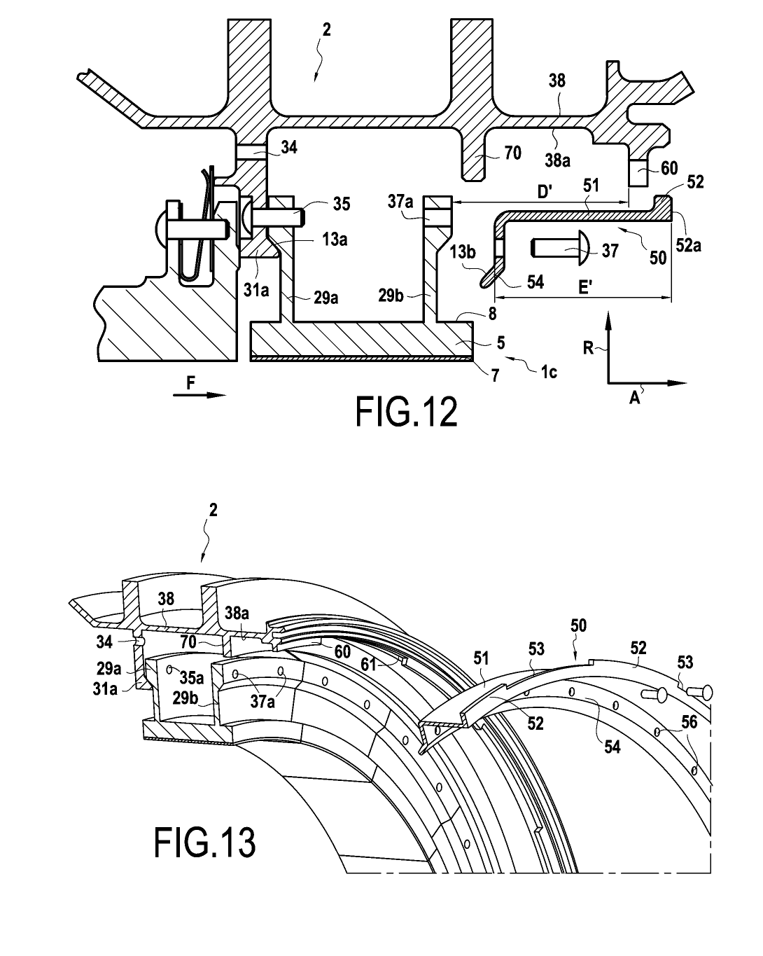

The ring support structure has at least one annular flange that is elastically deformable in the axial direction A of the ring. In the present example, the downstream annular radial flange 31b is elastically deformable. While mounting a ring sector 1c, the downstream annular radial flange 31b is pulled in the axial direction A, as shown in FIGS. 9 and 10 so as to increase the spacing between the flanges 31a and 31b and allow the tabs 29a and 29b to be inserted between the flanges 31a and 31b without risk of damage. Once the tabs 29a and 29b of a ring sector 1c are inserted between the flanges 31a and 31b and positioned so as to align the orifices 35a and 35b and also the orifices 37a and 37b, the flange 31b is released in order to hold the ring sector. In order to make it easier to pull the downstream annular radial flange 31b, it includes a plurality of hooks 25 that are distributed over its face 31c, i.e. its face opposite from the face 31d of the flange 31b that faces the downstream tabs 29b of the ring sectors 1c. In this example, the traction exerted on the elastically deformable flange 31b in the axial direction A is delivered by means of a tool 250 having at least one arm 251 with a hook 252 at its end that is engaged in the hook 25 present on the outside face 31c of the flange 31b.

The number of hooks 25 distributed over the face 31c of the flange 31b is defined as a function of the number of traction points that it is desired to have on the flange 31b. This number depends mainly on the elastic nature of the flange. Naturally, it is possible to envisage other shapes and arrangements of means that enable traction to be exerted on the flanges of the ring support structure in the axial direction A.

Once the ring sector 1c is inserted and in position between the flanges 31a and 31b, pegs 35 are engaged in the aligned orifices 35b and 35a formed respectively in the upstream annular radial flange 31a and in the upstream tab 29a, and pegs 37 are engaged in the aligned orifices 37b and 37a arranged respectively in the downstream annular radial flange 31b and in the downstream tab 29b. Each tab 29a or 29b of the ring sector may include one or more orifices for passing a blocking peg.

An analogous method may be used for mounting ring sectors for the embodiments shown in FIGS. 1, 3, and 4, with the exception that no blocking pegs are then used.

There follows a description of mounting ring sectors 1c for the embodiment of FIG. 6. As shown in FIG. 11, the ring sectors 1c are initially fastened via their upstream tabs 29a to the upstream annular radial flange 31a of the ring support structure 2 by pegs 35 that are engaged in the aligned orifices 35b and 35a formed respectively in the upstream annular radial flange 31a and in the upstream tab 29a.

Once all of the ring sectors 1c have been fastened in this way to the upstream annular radial flange 31a, the annular retention band 50 is assembled by twist-lock jaw coupling between the turbine casing and the downstream tabs 29b of the ring sectors. In the presently-described embodiment, the spacing E′ between the downstream annular radial flange 54 formed by the annular web 57 of the band 50 and the outer surfaces 52a of the teeth 52 of said band is greater than the distance D′ present between the outer faces 29d of the downstream tabs 29b of the ring sectors and the inner faces 60a of the teeth 60 present on the turbine casing. By defining a spacing E′ between the downstream annular radial flange and the outer surfaces of the teeth of the band that is greater than the distance D′ between the outer faces of the downstream tabs of the ring sectors and the inner faces of the teeth present on the turbine casing, it is possible to mount the ring sectors with prestress between the flanges of the ring support structure.

The ring support structure includes at least one annular flange that is elastically deformable in the axial direction A of the ring. In the presently-described example, it is the downstream annular radial flange 54 present on the band 50 that is elastically deformable. Specifically, the annular web 57 forming the downstream annular radial flange 54 of the ring support structure 2 is of small thickness compared with the upstream annular radial flange 31a, thereby giving it a certain amount of resilience.

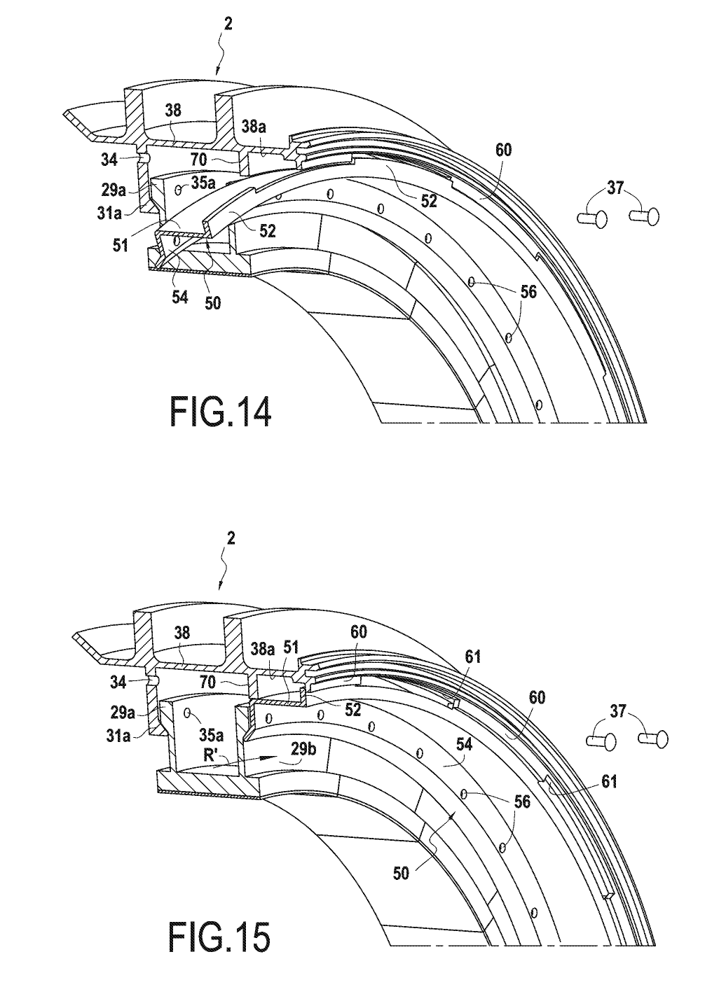

As shown in FIGS. 14 and 15, the band 50 is mounted on the turbine casing by placing the teeth 52 present on the band 50 in register with the engagement passages 61 formed on the turbine casing, the teeth 60 present on said turbine casing likewise being placed in register with the engagement passages 53 formed between the teeth 52 on the band 50. Since the spacing E′ is greater than the distance D′, it is necessary to apply an axial force on the band 50 in the direction shown in FIG. 14 in order to engage the teeth 52 beyond the teeth 60 and enable the band to be turned R′ through an angle corresponding substantially to the width of the teeth 60 and 52. After being turned in this way, the band 50 is released so that it is then held with axial stress between the downstream tabs 29b of the ring sectors and the inner surfaces 60a of the teeth 60 of the turbine casing.

Once the band has been put into place in this way, the pegs 37 are engaged in the aligned orifice 56 and 37a formed respectively in the downstream annular radial flange 54 and in the downstream tabs 29b. Each tab 29a or 29b of the ring sector may include one or more orifices for passing a blocking peg. The term “lying in the range . . . to . . . ” should be understood as including the bounds.

1. A turbine ring assembly comprising both a plurality of ring sectors made of ceramic matrix composite material forming a turbine ring, and also a ring support structure, each ring sector having a portion forming an annular base with an inner face defining the inside space of the turbine ring and an outer face from which an attachment portion of the ring sector extends for attaching it to the ring support structure, the ring support structure comprising two annular flanges between which the attachment portion of each ring sector is held, each of the annular flanges of the ring support structure presenting first and second sloping portions bearing against the attachment portions of the ring sectors and extending in non-parallel directions, each of said first and second sloping portions, when observed in meridian section, forming a non-zero angle relative to the radial direction and relative to the axial direction.

2. An assembly according to claim 1, wherein the first sloping portion bears against the upper halves of the attachment portions of the ring sectors and wherein the second sloping portion bears against the lower halves of the attachment portions of the ring sectors.

3. An assembly according to claim 1, wherein the annular flanges of the ring support structure grip the attachment portions of the ring sectors over at least half of the length l of said attachment portions.

4. An assembly according to claim 1, wherein the annular flanges of the ring support structure grip the attachment portions of the ring sectors at least at the radially outer ends of said attachment portions.

5. An assembly according to claim 1, wherein the attachment portion of each ring sector is in the form of tabs extending radially.

6. An assembly according to claim 5, wherein the radially outer ends of the ring sector tabs do not come into contact and wherein the tabs of the ring sectors define between them an internal ventilation volume for each of the ring sectors. cm 7. An assembly according to claim 1, wherein the attachment portion of each of the ring sectors is in the form of a bulb.

8. An assembly according to claim 1, wherein the ring sectors are of a section that is substantially Ω-shaped or substantially π-shaped.

9. A turbine engine including a turbine ring assembly according to claim 1.
